(19) United States
(12) Patent Application Publication
(10) Pub. No.: US 2007/0229365 A1
(43) Pub. Date: Oct. 4, 2007

(54) Transponder antenna

(76) Inventors: Roland Treutlein, Am Mitterweg (DE); Martin Bergsmann, Martinelligang (AT)

Correspondence Address: WENDEROTH, LIND & PONACK, L.L.P., 2033 K STREET N. W., SUITE 800, WASHINGTON, DC, 20006-1021, US

(21) Appl. No.: 11/727,103

(22) Filed: Mar. 23, 2007

(30) Foreign Application Priority Data
Mar. 29, 2006 (EP) 06 006 489.6

(51) Int. Cl. H01Q 1/38

(52) U.S. Cl. 343/700 MS

(57) ABSTRACT

Antenna for mounting ICs thereon, characterized in that the carrier substrate, on which the antenna is applied, is provided with an antistatic coating which does not negatively affect the function of the antenna.

The invention relates to a transponder antenna protected against static charging.

Transponder antennas are in general comprised of a partially conducting layer which is applied onto a flexible and/or rigid or semirigid substrate.

In mounting an IC (Integrated Circuit) onto an antenna, discharges may occur which may damage the IC or even destroy it. Destruction of the IC may already occur through discharge voltages starting at 60 V.

The cause of this is the static charging of the substrate which frequently occurs during the production process. Static charging occurs already during the unwinding of a substrate, during separation of the synthetic material layers or by friction. At high production rates in particular the risk of static charging is high. The tendency toward static charging is increased if the facility includes web guidance elements coated with synthetic materials, such that no discharges are possible. The advantage of these web guidance elements is that virtually no slipping occurs. When winding and unwinding the synthetic material sheeting, static discharges occur through friction.

To avoid such discharges, elements, such as copper garlands, discharge bars and the like, are currently applied in the facility, which prevent the static charging of the flexible substrate, However, these elements have so far not been capable of avoiding such discharges completely, such that destructions of ICs occur repeatedly during the production, the assembly or the lamination process. The elements are already ineffective in particular in the case of discharges which occur at voltages of a few kV. However, since discharges at significantly lower voltages can already damage or destroy the highly sensitive ICs, the demand exists for improved and reliable solutions to avoid the discharge.

The invention therefore addresses the problem of providing an antenna assemblage which is protected against static charging.

Subject matter of the invention is therefore an antenna onto which is mounted an IC, characterized in that the carrier substrate on which the antenna is applied is provided with an antistatic coating which does not negatively affect the function of the antenna.

The antistatic coating may be comprised of electrically conductive polymers, such as for example polyacetylene, poly-p-phenylene, polypyrroles, polythiophens, poly-p-phenylene vinyls, low-molecular macrocyclic semiconductors, organopolysilanes, polysulfur dinitride and/or polyanilines and/or their derivatives. As the electrically conductive polymers are especially preferred polyaniline or polyethylene dioxythiophen or polyethylene dioxythiophen methanol, Baytron® or Baymatec®, etc. The antistatic coating can further be comprised of a thin semitransparent metal layer or of a varnish layer filled with conducting particles or pigments, for example carbon black or metallic pigments or flakes, for example silver or copper pigments or flakes. The antistatic coating is applied in a thickness of 0.005-20 μm, preferably 0.1-10 μm onto the flexible carrier substrate of the antenna assemblage. The antistatic coating can be applied over the entire surface or partially, for example in the form of tracks or stripes in the proximity of the IC. Furthermore, the antistatic coating can be applied on one or on both sides.

Carrier substrates to be considered are for example flexible synthetic material sheets, for example of PI, PP, OPP, PE, PPS, PEEK, PEK, PEI, PAEK, LCP, PEN, PBT, PET, PA, PC, COC, POM, ABS, PVC, PTFE, fluorocarbon polymers such as Teflon, PVB, etc. The carrier sheets have preferably a thickness of 5-700 μm, preferred is a thickness of 5-200 μm, especially preferred 5-50 μm.

As carrier substrates can further be utilized fabrics or fibrous webs, such as continuous fiber webs, woven staple fiber webs and the like, which may optionally be needled and/or calendered. Such fabrics or fibrous webs are preferably comprised of synthetic materials, such as PP, PET, PA, PPS and the like. However, fabrics or fibrous webs of fibers of natural origin and optionally treated may also be employed, such as viscose fibers. The employed fibrous webs or fabrics have a mass per unit area of approximately 20 g/m² to 500 g/m². If necessary, the fibrous webs or fabrics must be surface treated.

Onto this carrier substrate is applied the antenna assemblage, which is substantially comprised of a conductive structure preferably of a metal, in particular copper or silver.

This assemblage can be applied using all known methods, for example known etching methods on a metal foil, lamination against a carrier or a layer applied by electroplating, printing or coating with a conductive paste with metallic pigments or by partial vapor deposition of the carrier substrate.

The structuring may, moreover, take place using known stamping methods.

The antistatic coating is preferably applied on the side of the carrier substrate opposite the antenna assemblage or on the side of the carrier substrate which supports the antenna assemblage or on both sides of the carrier substrate. The application can be carried out using any known coating methods, for example spin coating, spreading, vapor deposition, by printing (gravure, flexographic, screen, offset, digital printing or the like), by spraying, sputtering or roller application. The coating can be applied over the entire surface as well as also partially in the proximity of the IC, or as a dot or line screen.

The conductivity of the antistatic coating is set such that under the production conditions it prevents the charging of the carrier substrate, and, on the other hand, does not disturb the stray capacitance of the RLC circuit of the antenna or only insignificantly and therewith does not screen the antenna signal or put it out of tune.

The antennas according to the invention are utilized for electronic components, strip conductors, as RF antennas, for conductive contacts, terminal areas for printed electronic circuits or contact pins for ICs.

### EXAMPLES

### Example 1

Onto a PEN sheet having a thickness of 50 μm a partial copper layer of 1 μm thickness is vapor-deposited under vacuum. The partial copper coating forms the antenna. In the proximity of the IC, which is subsequently to be assembled, a partial coating of the conductive polymer Baytron CPP 105 (2 g/m²) is applied in the form of 2 cm wide stripes each.

### Example 2

The static charge of the material produced according to Example 1 was measured during the assembly process and compared with the material (comparison) not provided with a coating of conductive material in the proximity of the ICs to be assembled. The assembly rate was 5000 pieces/hr. The results are compiled in Table 1.

TABLE 1

| | Comparison | Example 1 |
|---|---|---|
| Measuring point | kV/inch | kV/inch |
| Surface of roll | 1.83 | −7.00 |
| Between first roll and | −1.20 | −2.00 |
| first guide roller | | |
| Assembly region | 0.80 | −0.15 |
| Checking region | 4.00 | −1.30 |
| Winding region | 3.50 | −7.20 |

1. Antenna onto which an IC can be mounted, wherein a carrier substrate, onto which the antenna is applied, is provided with an antistatic coating which does not negatively affect the function of the antenna.

2. Antenna as claimed in claim 1, wherein the carrier substrate is a flexible carrier substrate.

3. Antenna as claimed in claim 1, wherein the antistatic coating is comprised of an electrically conductive polymer.

4. Antenna as claimed in claim 1, wherein the antistatic coating is comprised of a varnish layer filled with conductive pigments.

5. Antenna as claimed in claim 3, wherein the antistatic coating is comprised of polyacetylene, poly-p-phenylene, polypyrroles, polythiophens, poly-p-phenylene vinyls, low-molecular macrocyclic semiconductors, organopolysilanes, polysulfur dinitride and/or polyanilines and/or their derivatives.

6. Antenna as claimed in claim 1, wherein the antistatic coating has a thickness of 0.05 to 20 μm.

7. Antenna as claimed in claim 1, wherein the antistatic coating has a thickness of 0.1 to 10 μm.

8. Antenna as claimed in claim 1, wherein the antistatic coating is comprised of a semitransparent conductive metal layer.

9. Antenna as claimed in claim 1, wherein the antistatic coating is applied partially or over the entire surface.

10. Antenna as claimed in claim 1 wherein the antistatic coating is applied on one side or on both sides on the carrier substrate.

11. Electronic components, strip conductors, RF antennas, conductive contacts, terminal areas for printed electronic circuits or contact pins for ICs comprising an antenna carrier substrate, onto which the antenna is applied, said substrate being provided with an antistatic coating which does not negatively affect the function of the antenna.
